(19) United States
(12) Patent Application Publication
(10) Pub. No.: US 2009/0163554 A1
(43) Pub. Date: Jun. 25, 2009

(54) Use of CNI-OD Formulations for Controlling White Fly

(75) Inventors: Isidro Bailo-Schleiermacher, Leverkusen (DE); Ronald Vermeer, Leverkusen (DE); Kai-Uwe Brueggen, Mumbai (IN); Heike Hungenberg, Langenfeld (DE); Wolfgang Thielert, Odenthal (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer Cropscience AG, Monheim (DE)

(21) Appl. No.: 12/066,034

(22) PCT Filed: Aug. 26, 2006
(86) PCT No.: PCT/EP2006/008387

§ 371 Date: Oct. 1, 2008

(30) Foreign Application Priority Data
Sep. 9, 2005 (DE) 10 2005 042 880.0

(51) Int. Cl. A01N 43/40; A01P 7/04

(52) U.S. Cl. 514/341

(57) ABSTRACT

Method of controlling eggs and nymphal stages of whitefly by the spray application of oil-based suspension concentrates containing at least one insecticide from the neonicotinyl series, at least one penetrant from the alcohol ethoxylate series, at least one vegetable oil, at least one nonionic surfactant and, if appropriate one or more additives.

Within the large group of sucking pests such as, for example, representatives from the orders Heteroptera and Homoptera, whiteflies (genus: Aleyrodina; family: Aleyrodidae), among them species such as Trialeurodes vaporariorum and in particular Bemisia tabaci are worldwide pest species in the production of many types of cereals and vegetables (Byrne & Bellows, Annual Review of Entomology (1991) 36, 431-457; Byrne et al., in: Whiteflies: their bionomics, pest status and management, Intercept, Andover, UK, 1990, pp. 227-267). Controlling this pest is therefore of great economical importance. The pesticides employed for this purpose include, inter alia, those which contain insecticides from the neonicotinyl series (for example imidacloprid or acetamiprid). Such a composition is sold for example under the name Confidor® SL 200 from Bayer CropScience (Monheim, Germany).

While these compositions are very effective against all lifecycles of the pest when they are applied systemically (as a pourable solution), they only afford inefficient protection against eggs and nymphs when applied as a spray treatment (Horowitz et al., Bulletin of Entomological Research (1988) 88, 437-442). The main reason is that eggs and nymphs are located on the underside of the leaves, where they are largely immobile. In the case of a traditional spray treatment, the insecticides therefore do not reach them, in contrast to the adults, and, after they have continued their development they lead to reinfestation of the plant with pests.

It has now been found, surprisingly, that certain formulations of neonicotinyls, when applied as a spray treatment, show a markedly improved effect against eggs and nymphal stages of whitefly over the established formulations when used in the same manner. These formulations take the form of oil-based suspension concentrates. Oil-based suspension concentrates are known (WO 03/000053, unpublished German Patent Applications Nos 102005018262.3 and 102004011007.7).

The invention therefore relates to the use of oil-based suspension concentrates containing at least one insecticide from the neonicotinyl series for controlling eggs and nymphal stages of whitefly by means of spray application.

Formulations which are suitable for the use according to the invention contain
at least one insecticide from the neonicotinyl series,
at least one penetrant,
at least one vegetable oil,
at least one nonionic surfactant or dispersant and/or at least one anionic surfactant or dispersant, and
if appropriate one or more additives from the group of the emulsifiers, the antifoam agents, the preservatives, the antioxidants, the colourants and/or the inert fillers.

Penetrants which are suitable in the present context are all those substances which are conventionally employed to improve the penetration of agrochemical active substances into plants. In the present context, penetrants are defined by the fact that they are capable of penetrating the cuticle of the plant from the aqueous spray mixture and/or from the spray coating, and thereby are capable of increasing the mobility of active substances in the cuticle. The method described in the literature (Baur et al., 1997, Pesticide Science 51, 131-152) can be employed for determining this characteristic.

Suitable formulations are prepared by mixing
at least one insecticide from the neonicotinyl series,
at least one penetrant,
at least one vegetable oil,
at least one nonionic surfactant or dispersant and/or at least one anionic surfactant or dispersant, and
if appropriate one or more additives from the group of the emulsifiers, the antifoam agents, the preservatives, the antioxidants, the colourants and/or the inert fillers
   and, if appropriate, grinding the resulting suspension.

Insecticides from the neonicotinyl series can be described by the following formula (II)

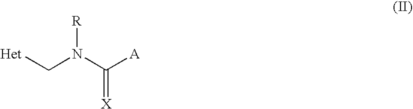

in which
Het represents a heterocycle selected from the following group of heterocycles: 2-chloropyrid-5-yl, 2-methylpyrid-5-yl, 1-oxido-3-pyridino, 2-chloro-1-oxido-5-pyridino, 2,3-dichloro-1-oxido-5-pyridino tetrahydrofuran-3-yl, 5-methyl-tetrahydrofuran-3-yl, 2-chlorothiazol-5-yl,
A represents N(R¹)(R²) or S(R²),
   where
R¹ represents hydrogen, C₁-C₆-alkyl, phenyl-C₁-C₄-alkyl, C₃-C₆-cycloalkyl, C₂-C₆-alkenyl or C₂-C₆-alkynyl, and
R² represents C₁-C₆-alkyl, C₂-C₆-alkenyl, C₂-C₆-alkynyl, —C(═O)—CH₃ or benzyl,
R represents C₁-C₆-alkyl, C₂-C₆-alkenyl, C₂-C₆-alkynyl, —C(═O)—CH₃ or benzyl or together with R² represents one of the following groups:
—CH₂—CH₂—, —CH₂—CH₂—CH₂—, —CH₂—O—CH₂—, —CH₂—S—CH₂—, —CH₂—NH—CH₂—, —CH₂—N—(CH₃)—CH₂— and
X represents N—NO₂, N—CN or CH—NO₂
   (see, for example, EP-A1-192 606, EP-A2-580 533, EP-A2-376 279, EP-A2-235 725).

The following compounds which can be used in accordance with the invention may be mentioned individually.

A compound which is preferably used in accordance with the invention is thiamethoxam.

Thiamethoxam has the formula

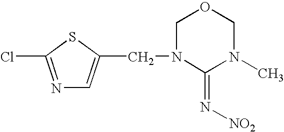

and is known from EP A2 0 580 533.

A further compound which is preferably used in accordance with the invention is clothianidin.

Clothianidin has the formula

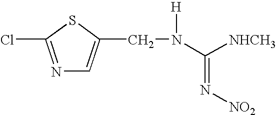

and is known from EP A2 0 376 279.

A further compound which is preferably used in accordance with the invention is thiacloprid.

Thiacloprid has the formula

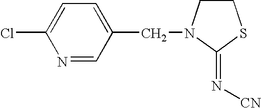

and is known from EP A2 0 235 725.

A further compound which is preferably used in accordance with the invention is dinotefuran.

Dinotefuran has the formula

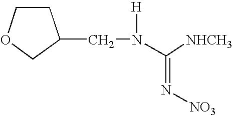

and is known from EP A10 649 845.

A further compound which is preferably used in accordance with the invention is acetamiprid.

Acetamiprid has the formula

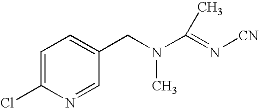

and is known from WO A1 91/04965.

A further compound which is preferably used in accordance with the invention is nitenpyram.

Nitenpyram has the formula

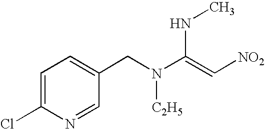

and is known from EP A2 0 302 389.

A further compound which is preferably used in accordance with the invention is imidacloprid.

Imidacloprid has the formula

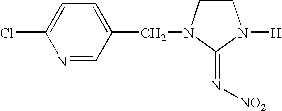

and is known from EP 0 192 060.

A compound which is especially preferably used in accordance with the invention is imidacloprid.

Preferred penetrants are alkanol alkoxylates of the formula

R—O—(-AO)ₘR′ (I)

in which
R represents straight-chain or branched alkyl having 4 to 20 carbon atoms,
R′ represents H, methyl, ethyl, n-propyl, i-propyl, n-butyl, i-butyl, t-butyl, n-pentyl or n-hexyl,
AO represents an ethylene oxide residue, a propylene oxide residue, a butylene oxide residue or mixtures of ethylene oxide and propylene oxide residues or butylene oxide residues and
m represents numbers from 2 to 30.

An especially preferred group of penetrants are alkanol alkoxylates of the formula

R—O—(-EO—)ₙ—R′ (Ia)

in which
R has the abovementioned meaning,
R′ has the abovementioned meaning,
EO represents —CH₂—CH₂—O— and
n represents numbers from 2 to 20.

A further especially preferred group of penetrants are alkanol alkoxylates of the formula Ia

in which
R represents branched or unbranched C₁₀-C₁₄-alkyl,
EO represents —CH₂—CH₂—O— and
n 6, 7, 8, 9 or 10 and
R′ represents hydrogen, methyl, ethyl, n-propyl, i-propyl, n-butyl, i-butyl, t-butyl, n-pentyl or n-hexyl, in particular hydrogen.

A further especially preferred group of penetrants are alkanol alkoxylates of the formula

R—O—(-EO—)ₚ—(—PO—)_{q}—R′ (Ib)

in which
R has the abovementioned meaning,
R′ has the abovementioned meaning,
EO represents —CH₂—CH₂—O—,
PO represents

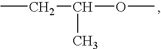

p represents numbers from 1 to 10 and
q represents numbers from 1 to 10.

A further especially preferred group of penetrants are alkanol alkoxylates of the formula

R—O—(—PO—)ᵣ—(EO—)_{S}—R′ (Ic)

in which
R has the abovementioned meaning,
R′ has the abovementioned meaning,
EO represents —CH₂—CH₂—O—,
PO represents

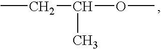

r represents numbers from 1 to 10 and
s represents numbers from 1 to 10.

A further especially preferred group of penetrants are alkanol alkoxylates of the formula

R—O—(-EO—)ₚ—(—BO—)_{q}—R′ (Id)

in which
R and R′ have the abovementioned meanings,
EO represents CH₂—CH₂—O—,
BO represents

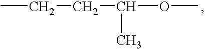

p represents numbers from 1 to 10 and
q represents numbers from 1 to 10.

A further especially preferred group of penetrants are alkanol alkoxylates of the formula

R—O—(—BO—)ᵣ—(-EO—)_{S}—R′ (Ie)

in which
R and R′ have the abovementioned meanings,
BO represents

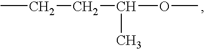

EO represents CH₂—CH₂—O—,
r represents numbers from 1 to 10 and
s represents numbers from 1 to 10.

A further especially preferred group of penetrants are alkanol alkoxylates of the formula

CH₃—(CH₂)ₜ—CH₂—O—(—CH₂—CH₂—O—)ᵤ—R′ (If)

in which
R′ has the abovementioned meaning,
t represents numbers from 8 to 13
   and
u represents numbers from 6 to 17.

In the above formula,
R preferably represents butyl, i-butyl, n-pentyl, i-pentyl, neopentyl, n-hexyl, i-hexyl, n-octyl, i-octyl, 2-ethylhexyl, nonyl, i-nonyl, decyl, n-dodecyl, i-dodecyl, lauryl, myristyl, i-tridecyl, trimethylnonyl, palmityl, stearyl or eicosyl.

An example of an alkanol alkoxylate of the formula (Ia) which may be mentioned is the compound of the formula

R—O—(-EO—)ₙ—R′ (Ia-1)

in which
R represents branched C₁₂- to C₁₋₄-alkyl,
n represents 6 (the number 6 being an average value) and
R′ represents hydrogen.

An example of an alkanol alkoxylate of the formula (Ic) which may be mentioned is 2-ethylhexyl alkoxylate of the formula

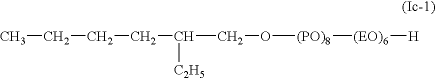

in which
EO represents CH₂—CH₂—O—,
PO represents

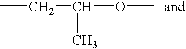

the numbers 8 and 6 represent averages.

An example of an alkanol alkoxylate of the formula (Id) which may be mentioned is the compound

CH₃—(CH₂)₁₀—O—(-EO—)₆—(—BO—)₂—CH₃ (Id-1)

in which
EO represents CH₂—CH₂—O—,
BO represents

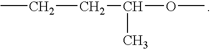

An example of an alkanol alkoxylate of the formula (If) which may be mentioned is the compound (If-1)

CH₃—(CH₂)_{10.5}—CH₂—O—(—CH₂—CH₂—O—)_{8.4}—R′ (If-1)

in which 10.5 and 8.4 are average values.

Formula (I) hereinabove provides a general definition of the alkanol alkoxylates. These substances take the form of mixtures of substances of the type indicated with different chain lengths. This is why average values, which may deviate from integers, are calculated for the indices.

The alkanol alkoxylates of the formula indicated are known or can be prepared by known methods (cf. WO 98-35 553, WO 00-35 278 and EP-A 0 681 865).

Suitable vegetable oils are all oils which can be obtained from plants and which can typically be employed in agrochemical compositions. Examples which may be mentioned are sunflower oil, rapeseed oil, olive oil, castor oil, turnip rape oil, corn oil, cottonseed oil and soya oil.

The oil-based suspension concentrates which can be employed in accordance with the invention comprise at least one nonionic surfactant or dispersant and/or at least one anionic surfactant or dispersant.

Suitable nonionic surfactants or dispersants are all substances of this type which can conventionally be employed in agrochemical compositions. The following may be mentioned by way of preference: polyethylene oxide/polypropylene oxide block copolymers, polyethylene glycol ethers of linear alcohols, reaction products of fatty acids with ethylene oxide and/or propylene oxide, furthermore polyvinyl alcohol, polyvinylpyrrolidone, mixed polymers of polyvinyl alcohol and polyvinylpyrrolidone and copolymers of (meth)acrylic acid and (meth)acrylic esters, furthermore alkyl ethoxylates and alkylaryl ethoxylates, all of which can, if appropriate, be phosphated and, if appropriate, neutralized with bases, examples which may be mentioned being sorbitol ethoxylates, and also polyoxyalkyleneamine derivatives.

Suitable anionic surfactants are all substances of this type which can conventionally be used in agrochemical compositions. Preferred are alkali metal salts and alkaline earth metal salts of alkylsulphonic acids or alkylarylsulphonic acids.

A further preferred group of anionic surfactants or dispersants are salts of polystyrenesulphonic acids, salts of polyvinylsulphonic acids, salts of naphthalenesulphonic acid formaldehyde condensates, salts condensates of naphthalenesulphonic acid, phenolsulphonic acid and formaldehyde and salts of lignosulphonic acid, all of which are sparingly soluble in vegetable oil.

Suitable additives which may be present in the formulations which can be employed in accordance with the invention are emulsifiers, antifoam agents, preservatives, antioxidants, colourants and inert fillers.

Preferred emulsifiers are ethoxylated nonylphenols, reaction products of alkylphenols and ethylene oxide and/or propylene oxide, ethoxylated arylalkylphenols, furthermore ethoxylated and propoxylated arylalkylphenols, and sulphated or phosphated arylalkyl ethoxylates or arylalkyl ethoxypropoxylates, examples which may be mentioned being sorbitan derivatives such as polyethylene oxide sorbitan fatty acid esters and sorbitan fatty acid esters.

Antifoam agents which are suitable are all substances which can be employed for this purpose in agrochemical compositions. Silicone oils and magnesium stearate are preferred.

Suitable preservatives are all substances which can conventionally be employed for this purpose in agrochemical compositions of this type. Examples which may be mentioned are Preventol® (Bayer AG) and Proxel®.

Suitable antioxidants are all substances which can conventionally be employed for this purpose in agrochemical compositions. Butylhydroxytoluene and/or citric acid are preferred.

Colourants are all substances which can conventionally be employed for this purpose in agrochemical compositions. Examples which may be mentioned are titanium dioxide, colour black, zinc oxide and blue pigments and Permanent red FGR.

Suitable inert fillers are all substances which can conventionally be employed for this purpose in agrochemical compositions and which do not act as thickeners. Preferred are inorganic particles such as carbonates, silicates and oxides, and also organic substances, such as urea/formaldehyde condensates. Examples which may be mentioned are kaolin, rutile, silicon dioxide, what is known as highly disperse silica, silica gels, and natural and synthetic silicates, and furthermore talc.

The formulations which can be employed in accordance with the invention can, in a particular embodiment, additionally contain at least one further active substance (insecticides, attractants, sterilants, bactericides, acaricides, nematicides, fungicides, growth-regulating substances or herbicides). The insecticides include, for example, phosphoric esters, carbamates, carboxylic esters, chlorinated hydrocarbons, phenylurea, substances produced by microorganisms and the like.

Especially advantageous mixing partners are, for example, the following:

### Fungicides:

### Nucleic Acid Synthesis Inhibitors

benalaxyl, benalaxyl-M, bupirimate, chiralaxyl, clozylacon, dimethirimol, ethirimol, furalaxyl, hymexazol, metalaxyl, metalaxyl-M, ofurace, oxadixyl, oxolinic acid

### Mitosis and Cell Division Inhibitors

benomyl, carbendazim, diethofencarb, fuberidazole, pencycuron, thiabendazol, thiophanate-methyl, zoxamid

### Respiratory Chain Complex I Inhibitors

diflumetorim

### Respiratory Chain Complex II Inhibitors

boscalid, carboxin, fenfuram, flutolanil, furametpyr, mepronil, oxycarboxin, penthiopyrad, thifluzamid

### Respiratory Chain Complex III Inhibitors

azoxystrobin, cyazofamid, dimoxystrobin, enestrobin, famoxadon, fenamidon, fluoxastrobin, kresoxim-methyl, metominostrobin, orysastrobin, pyraclostrobin, picoxystrobin

### Uncouplers

dinocap, fluazinam

### ATP Production Inhibitors

fentin acetate, fentin chloride, fentin hydroxide, silthiofam

### Amino Acid and Protein Biosynthesis Inhibitors

andoprim, blasticidin-S, cyprodinil, kasugamycin, kasugamycin hydrochloride hydrate, mepanipyrim, pyrimethanil

### Signal Transduction Inhibitors

fenpiclonil, fludioxonil, quinoxyfen

### Fat and Membrane Synthesis Inhibitors

chlozolinate, iprodione, procymidon, vinclozolin
ampropylfos, potassium-ampropylfos, edifenphos, iprobenfos (IBP), isoprothiolan, pyrazophos
tolclofos-methyl, biphenyl
iodocarb, propamocarb, propamocarb hydrochloride

### Ergosterol Biosynthesis Inhibitors

fenhexamid,
azaconazole, bitertanol, bromuconazole, cyproconazole, diclobutrazol, difenoconazole, diniconazole, diniconazole-M, epoxiconazole, etaconazole, fenbuconazole, fluquinconazole, flusilazol, flutriafol, furconazole, furconazole-cis, hexaconazole, imibenconazole, ipconazole, metconazole, myclobutanil, paclobutrazol, penconazole, propiconazole, prothioconazole, simeconazole, tebuconazole, tetraconazole, triadimefon, triadimenol, triticonazole, uniconazole, voriconazole, imazalil, imazalil sulphate, oxpoconazole, fenarimol, flurprimidol, nuarimol, pyrifenox, triforin, pefurazoat, prochloraz, triflumizol, viniconazole,
aldimorph, dodemorph, dodemorph acetate, fenpropimorph, tridemorph, fenpropidin, spiroxamin,
naffifin, pyributicarb, terbinafin

### Cell Wall Synthesis Inhibitors

benthiavalicarb, bialaphos, dimethomorph, flumorph, iprovalicarb, polyoxins, polyoxorim, validamycin A

### Melanin Biosynthesis Inhibitors

capropamid, diclocymet, fenoxanil, phtalid, pyroquilon, tricyclazol

### Resistance Induction

acibenzolar-S-methyl, probenazol, tiadinil

### Multisite

captafol, captan, chlorothalonil, copper salts such as: copper hydroxide, copper naphthenate, copper oxychloride, copper sulphate, copper oxide, oxine-copper and Bordeaux mixture, dichlofluanid, dithianon, dodine, dodine free base, ferbam, fluorofolpet, guazatine, guazatine acetate, iminoctadine, iminoctadine albesilate, iminoctadine triacetate, mancopper, mancozeb, maneb, metiram, metiram-zinc, propineb, sulphur and sulphur preparations comprising calcium polysulphide, thiram, tolylfluanid, zineb, ziram

### Unknown Mechanism

amibromdol, benthiazole, bethoxazin, capsimycin, carvone, quinomethionate, chloropicrin, cufraneb, cyflufenamid, cymoxanil, dazomet, debacarb, diclomezine, dichlorophen, dicloran, difenzoquat, difenzoquat methyl sulphate, diphenylamine, ethaboxam, ferimzone, flumetover, flusulfamid, fluopicolid, fluoroimide, hexachlorobenzene, 8-hydroxyquinoline sulphate, irumamycin, methasulphocarb, metrafenon, methyl isothiocyanate, mildiomycin, natamycin, nickel dimethyldithiocarbamate, nitrothal-isopropyl, octhilinone, oxamocarb, oxyfenthiin, pentachlorophenol and salts, 2-phenylphenol and salts, piperaline, propanosine-sodium, proquinazid, pyrrolenitrine, quintozene, tecloftalam, tecnazene, triazoxide, trichlamid, zarilamid and 2,3,5,6-tetrachloro-4-(methylsulphonyl)pyridine, N-(4-chloro-2-nitrophenyl)-N-ethyl-4-methylbenzenesulphonamide, 2-amino-4-methyl-N-phenyl-5-thiazolecarboxamide, 2-chloro-N-(2,3-dihydro-1,1,3-trimethyl-1H-inden-4-yl)-3-pyridinecarboxamide, 3-[5-(4-chlorophenyl)-2,3-dimethylisoxazolidin-3-yl]pyridine, cis-1-(4-chlorophenyl)-2-(1H-1,2,4-triazol-1-yl)cycloheptanol, 2,4-dihydro-5-methoxy-2-methyl-4-[[[[1-[3-(trifluoromethyl)phenyl]ethylidene]amino]oxy]methyl]phenyl]-3H-1,2,3-triazol-3-one (185336-79-2), methyl 1-(2,3-dihydro-2,2-dimethyl-1H-inden-1-yl)-1H-imidazole-5-carboxylate, 3,4,5-trichloro-2,6-pyridinedicarbonitrile, methyl 2-[[[cyclopropyl[(4-methoxyphenyl)imino]methyl]thio]methyl]-alpha-(methoxymethylene)benzacetate, 4-chloro-alpha-propynyloxy-N-[2-[3-methoxy-4-(2-propynyloxy)phenyl]ethyl]benzacetamide, (2S)—N-[2-[4-[[3-(4-chlorophenyl)-2-propynyl]oxy]-3-methoxyphenyl]ethyl]-3-methyl-2-[(methylsulphonyl)amino]butanamide, 5-chloro-7-(4-methylpiperidin-1-yl)-6-(2,4,6-trifluorophenyl)[1,2,4]triazolo[1,5-a]pyrimidine, 5-chloro-6-(2,4,6-trifluorophenyl)-N-[(1R)-1,2,2-trimethylpropyl][1,2,4]triazolo[1,5-a]pyrimidine-7-amine, 5-chloro-N-[(1R)-1,2-dimethylpropyl]-6-(2,4,6-trifluorophenyl) [1,2,4]triazolo[1,5-a]pyrimidine-7-amine, N-[1-(5-bromo-3-chloropyridin-2-yl)ethyl]-2,4-dichloronicotinamide, N-(5-bromo-3-chloropyridin-2-yl)methyl-2,4-dichloronicotinamide, 2-butoxy-6-iodo-3-propylbenzopyranon-4-one, N-{(Z)-[(cyclopropylmethoxy)imino][6-(difluoromethoxy)-2,3-difluorophenyl]methyl}-2-benzacetamide, N-(3-ethyl-3,5,5-trimethylcyclohexyl)-3-formylamino-2-hydroxybenzamide, 2-[[[[1-[3(1-fluoro-2-phenylethyl)oxy]phenyl]ethylidene]amino]oxy]methyl]-alpha-(methoxyimino)-N-methyl-alphaE-benzacetamide, N-{2-[3-chloro-5-(trifluoromethyl)pyridin-2-yl]ethyl}-2-(trifluoromethyl)benzamide, N-(3′,4′-dichloro-5-fluorobiphenyl-2-yl)-3-(difluoromethyl)-1-methyl-1H-pyrazole-4-carboxamide, N-(6-methoxy-3-pyridinyl)cyclopropanecarboxamide, 1-[(4-methoxyphenoxy)methyl]-2,2-dimethylpropyl-1H-imidazole-1-carboxylic acid, 0-[1-[(4-methoxyphenoxy)methyl]-2,2-dimethylpropyl]-1H-imidazol-1-carbothioic acid, 2-(2-{[6-(3-chloro-2-methylphenoxy)-5-fluoropyrimidin-4-yl]oxy}phenyl)-2-(methoxyimino)-N-methylacetamide

### Bactericides:

bronopol, dichlorophen, nitrapyrin, nickel dimethyldithiocarbamate, kasugamycin, octhilinone, furancarboxylic acid, oxytetracyclin, probenazole, streptomycin, tecloftalam, copper sulphate and other copper preparations.

### Insecticides/Acaricides/Nematicides:

### Acetylcholine Esterase (AChE) Inhibitors

carbamates,
for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulphan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, triazamate
organophosphates,
for example acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chloropyrifos (-methyl/-ethyl), coumaphos, cyanofenphos, cyanophos, chlorfenvinphos, demeton-5-methyl, demeton-5-methylsulphon, dialifos, diazinon, dichlofenthion, dichlorvos/DDVP, dicrotophos, dimethoate, dimethylvinphos, dioxabenzofos, disulphoton, EPN, ethion, ethoprophos, etrimfos, famphur, fenamiphos, fenitrothion, fensulphothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion

### Sodium Channel Modulators/Voltage-Dependent Sodium Channel Blockers

pyrethroids,
for example acrinathrin, allethrin (d-cis-trans, d-trans), beta-cyfluthrin, bifenthrin, bioallethrin, bioallethrin-5-cyclopentyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R trans isomer), prallethrin, profluthrin, protrifenbute, pyresmethrin, resmethrin, RU 15525, silafluofen, tau-fluvalinate, tefluthrin, terallethrin, tetramethrin (1R isomer), tralomethrin, transfluthrin, ZXI 8901, pyrethrins (pyrethrum)
DDT
oxadiazines,
for example indoxacarb

### Acetylcholine Receptor Agonists/Antagonists

chloronicotinyls,
for example acetamiprid, clothianidin, dinotefuran, imidacloprid, nitenpyram, nithiazine, thiacloprid, thiamethoxam
nicotine, bensultap, cartap

### Acetylcholine Receptor Modulators

spinosyns,
for example spinosad

### GABA-Controlled Chloride Channel Antagonists

organochlorines,
for example camphechlor, chlordane, endosulphan, gamma-HCH, HCH, heptachlor, lindane, methoxychlor
fiprols,
for example acetoprole, ethiprole, fipronil, pyrafluprole, pyriprole, vaniliprole

### Chloride Channel Activators

mectins,
for example avermectin, emamectin, emamectin-benzoate, ivermectin, milbemycin

### Juvenile Hormone Mimetics,

for example diofenolan, epofenonane, fenoxycarb, hydroprene, kinoprene, methoprene, pyriproxifen, triprene

### Ecdysone Agonists/Disruptors

diacylhydrazines,
for example chromafenozide, halofenozide, methoxyfenozide, tebufenozide

### Chitin Biosynthesis Inhibitors

benzoylureas,
for example bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron
buprofezin
cyromazine

### Inhibitors of Oxidative Phosphorylation, ATP Disruptors

diafenthiuron
organotin compounds
for example azocyclotin, cyhexatin, fenbutatin-oxide
   Uncouplers of oxidative phoshorylation by interrupting the H proton gradient
pyrroles,
for example chlorfenapyr
dinitrophenols,
for example binapacyrl, dinobuton, dinocap, DNOC

### Site-I Electron Transport Inhibitors

METIs,
for example fenazaquin, fenpyroximate, pyrimidifen, pyridaben, tebufenpyrad, tolfenpyrad
hydramethylnon
dicofol

### Site-II Electron Transport Inhibitors

rotenone

### Site-EI Electron Transport Inhibitors

acequinocyl, fluacrypyrim

### Microbial Disruptors of the Insect Gut Membrane

Bacillus thuringiensis strains

### Fat Biosynthesis Inhibitors

tetronic acids,
for example spirodiclofen, spiromesifen
tetramic acids,
for example spirotetramat (CAS-Reg.-No.: 203313-25-1) and 3-(2,5-dimethylphenyl)-8-methoxy-2-oxo-1-azaspiro[4.5]dec-3-en-4-yl ethyl carbonate (also known as: carbonic acid, 3-(2,5-dimethylphenyl)-8-methoxy-2-oxo-1-azaspiro[4.5]dec-3-en-4-yl ethyl ester, CAS-Reg.-No.: 382608-10-8)
carboxamides,
for example flonicamid
octopaminergic agonists,
for example amitraz

### Inhibitors of Magnesium-Stimulated ATPase,

propargite
benzoic acid dicarboxamides,
for example flubendiamide
nereistoxin analogues,
for example thiocyclam hydrogen oxalate, thiosultap-sodium

### Biologicals, Hormones or Pheromones

azadirachtin, Bacillus spec., Beauveria spec., codlemone, Metarrhizium spec., Paecilomyces spec., Thuringiensin, Verticillium spec.
   Active Compounds with Unknown or Unspecific Mechanisms of Action
fumigants,
for example aluminium phosphide, methyl bromide, sulphuryl fluoride
antifeedants,
for example cryolite, flonicamid, pymetrozine
mite growth inhibitors,
for example clofentezine, etoxazole, hexythiazox
amidoflumet, benclothiaz, benzoximate, bifenazate, bromopropylate, buprofezin, quinomethionate, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyridalyl, sulfluramid, tetradifon, tetrasul, triarathene, verbutin

The content of the individual components in the oil-based suspension concentrates which can be employed in accordance with the invention may be varied within a substantial range. Thus, the concentrations
of agrochemical active substances are generally between 5 and 40% by weight, preferably between 10 and 37.5% by weight, very especially preferably between 20 and 35% by weight,
of penetrant generally between 5 and 55% by weight, preferably between 15 and 40% by weight,
of vegetable oil generally between 15 and 55% by weight, preferably between 20 and 50% by weight,
of surfactants and/or dispersants generally between 2.5 and 30% by weight, preferably between 5.0 and 25% by weight, and
of additives generally between 0 and 25% by weight, preferably between 0 and 20% by weight.

The oil-based suspension concentrates according to the invention are prepared in such a manner that the components are mixed with one another in the desired ratios. The order in which the constituents are combined with one another is freely chooseable. The solid components are expediently employed in the finely ground state. However, it is also possible to subject the suspension which is formed after combining the components first to coarse milling and then to fine milling, so that the mean particle size is below 20 μm. Preferred suspension concentrates are those in which the solid particles have a mean particle size of between 1 and 10 μm.

When carrying out the method according to the invention, the temperatures can be varied within a certain range. In general, the process is carried out at temperatures between 10° C. and 60° C., preferably between 15° C. and 40° C.

Conventional mixing and grinding apparatuses which are employed for the preparation of agrochemical formulations are suitable for carrying out the method according to the invention.

The oil-based suspension concentrates according to the invention take the form of formulations which remain stable even following prolonged storage at elevated temperatures or in the cold since no crystal growth is observed. They can be converted into homogeneous spray mixtures by dilution with water. These spray mixtures are applied by spraying.

The application rate of the oil-based suspension concentrates according to the invention can be varied within a substantial range. It depends on the agrochemical active substances in question and on their content in the formulations.

With the aid of the oil-based suspension concentrates according to the invention it is possible to apply agrochemical active substances, in particular those from the neonicotinyls, in a particularly advantageous manner to plants and/or their environment.

The formulations according to the invention can be used to treat all plants and plant parts. In the present context, plants are understood as meaning all plants and plant populations, such as desired and undesired wild plants or crop plants (including naturally occurring crop plants). Crop plants can take the form of plants which can be obtained by conventional breeding and optimization methods or by biotechnological and recombinant methods or by combinations of these methods, including the transgenic plants and including the plant varieties capable or not of being protected by Plant Breeders' Rights. Plant parts are understood as meaning all aerial and subterranean parts and organs of the plants such as shoot, leaf, flower and root, examples which may be mentioned being leaves, needles, stalks, stems, flowers, fruiting bodies, fruits and seeds, and also roots, tubers and rhizomes. The plant parts also include harvested material and vegetative and generative propagation material, for example cuttings, tubers, rhizomes, slips and seeds.

What must be emphasized here is the especially advantageous effect of the compositions according to the invention regarding the use in cereal plants such as, for example, wheat, oats, barley, spelt, triticale and rye, but also in maize, millet and sorghum, rice, sugarcane, soybeans, sunflowers, potatoes, cotton, oilseed rape, canola, tobacco, sugar beet, fodder beet, asparagus, hops and fruit plants (comprising pome fruit such as, for example, apples and pears, stone fruit such as, for example, peaches, nectarines, cherries, plums and apricots, citrus fruits such as, for example, oranges, grapefruits, limes, lemons, cumquats, tangerines and satsumas, nuts such as, for example, pistachios, almonds, walnuts and pecan nuts, tropical fruits such as, for example, mango, papaya, pineapple, dates and bananas, and grapes) and vegetables (comprising leafy vegetables such as, for example, endives, corn salad, Florence fennel, lettuce, cos lettuce, Swiss chard, spinach and chicory, cabbages such as, for example, cauliflower, broccoli, Chinese leaves, borecole (curly kale, feathered cabbage), kohlrabi, Brussels sprouts, red cabbage, white cabbage and savoy cabbage, fruit vegetables such as, for example, aubergines, cucumbers, capsicums, table pumpkins, tomatoes, courgettes and sweet corn, root vegetables such as, for example, celeriac, early turnips, carrots, including yellow cultivars, radish, including small radish, beetroot, scorzonera and celery, pulses such as, for example, beans and peas, and bulb vegetables such as, for example, leeks and table onions).

The treatment according to the invention of the plants and plant parts with the formulations according to the invention is carried out directly or by acting on their environment, habitat or storage area in accordance with the customary treatment methods, for example by dipping, spraying, vaporizing, misting, scattering or painting on and, in the case of propagation materials, in particular in the case of seeds, furthermore by applying one or more coats.

The agrochemical active substances which are present display a better biological activity against all stages of whitefly than when applied in the form of the corresponding traditional formulations.

The invention is illustrated by the examples which follow. The examples are not to be construed as limiting.

### PREPARATION EXAMPLES

### Example 1

To prepare a suspension concentrate according to the invention,

183 g of imidacloprid,
100 g of Arlatone T from Uniqema
25 g of Atlox MBA 13/20 from Uniqema
42 g of Atlox 4838 B from Uniqema
20 g of Borresperse NA from Borregaard LignoTech
0.5 g of Silicon Antischaummittel 1132 from Wacker
2 g of butylhydroxytoluene from Bayer
are introduced with stirring at room temperature into a mixture of
200 g of alkanol alkoxylate of the formula Ia-1, and
427.5 g of sunflower oil.

After the end of the addition, the mixture is stirred at room temperature for a further 10 minutes. The resultant homogeneous suspension is subjected first to coarse grinding and then to fine grinding, giving a suspension in which 90% of the solids particles have a size of below 6 μm.

### Example 2

To prepare a suspension concentrate according to the invention,

196 g of imidacloprid,
100 g of Arlatone T from Uniqema
50 g of Atlox MBA PS 2 from Uniqema
50 g of Borresperse NA from Borregaard LignoTech
1 g of Antifoam 1500 from Dow Corning
2 g of butylhydroxytoluene from Bayer
are introduced with stirring at room temperature into a mixture of
200 g of alkanol alkoxylate of the formula Ia-1, and
401 g of sunflower oil.

After the end of the addition, the mixture is stirred at room temperature for a further 10 minutes. The resultant homogeneous suspension is subjected first to coarse grinding and then to fine grinding, giving a suspension in which 90% of the solids particles have a size of below 6 μm.

### Example 3

To prepare a suspension concentrate according to the invention,

196 g of imidacloprid,
100 g of Arlatone T from Uniqema
50 g of Atlas G 1281 from Uniqema
50 g of Borresperse NA from Borregaard LignoTech
0.5 g of Silicon Antischaummittel 1132 from Wacker
2 g of butylhydroxytoluene from Bayer
are introduced with stirring at room temperature into a mixture of
200 g of alkanol alkoxylate of the formula Ia-1, and
401.5 g of sunflower oil.

After the end of the addition, the mixture is stirred at room temperature for a further 10 minutes. The resultant homogeneous suspension is subjected first to coarse grinding and then to fine grinding, giving a suspension in which 90% of the solids particles have a size of below 6 μm.

### Example 4

To prepare a suspension concentrate according to the invention,

320 g of imidacloprid,
100 g of Arlatone T from Uniqema
50 g of Atlox PS 2 from Uniqema
30 g of Borresperse NA from Borregaard LignoTech
0.5 g of Silicon Antischaummittel 1132 from Wacker
2 g of butylhydroxytoluene from Bayer
are introduced with stirring at room temperature into a mixture of
200 g of alkanol alkoxylate of the formula Ia-1, and
297.5 g of sunflower oil.

After the end of the addition, the mixture is stirred at room temperature for a further 10 minutes. The resultant homogeneous suspension is subjected first to coarse grinding and then to fine grinding, giving a suspension in which 90% of the solids particles have a size of below 6 μm.

### Example 5

To prepare a suspension concentrate according to the invention,

231 g of imidacloprid,
100 g of Arlatone T from Uniqema
50 g of Atlox PS 2 from Uniqema
20 g of Borresperse NA from Borregaard LignoTech
0.5 g of Silicon Antischaummittel 1132 from Wacker
2 g of butylhydroxytoluene from Bayer
are introduced with stirring at room temperature into a mixture of
200 g of alkanol alkoxylate of the formula Ia-1, and
396.5 g of sunflower oil.

After the end of the addition, the mixture is stirred at room temperature for a further 10 minutes. The resultant homogeneous suspension is subjected first to coarse grinding and then to fine grinding, giving a suspension in which 90% of the solids particles have a size of below 6 μm.

### Example 6

To prepare a suspension concentrate according to the invention,

196 g of imidacloprid,
100 g of Arlatone T from Uniqema
50 g of Atlox 4894 from Uniqema
5 g of Morwet D 425 from Akzo Nobel
0.5 g of Silicon Antischaummittel 1132 from Wacker
2 g of butylhydroxytoluene from Bayer
are introduced with stirring at room temperature into a mixture of
200 g of alkanol alkoxylate of the formula Ic-1, and
446.5 g of sunflower oil.

After the end of the addition, the mixture is stirred at room temperature for a further 10 minutes. The resultant homogeneous suspension is subjected first to coarse grinding and then to fine grinding, giving a suspension in which 90% of the solids particles have a size of below 6 μm.

### Example 7

To prepare a suspension concentrate according to the invention,

196 g of imidacloprid,
100 g of Arlatone T from Uniqema
100 g of Atlox 3467 from Uniqema
0.5 g of Silicon Antischaummittel 1132 from Wacker
2 g of butylhydroxytoluene from Bayer
are introduced with stirring at room temperature into a mixture of
200 g of alkanol alkoxylate of the formula Ic-1, and
401.5 g of sunflower oil.

After the end of the addition, the mixture is stirred at room temperature for a further 10 minutes. The resultant homogeneous suspension is subjected first to coarse grinding and then to fine grinding, giving a suspension in which 90% of the solids particles have a size of below 6 μm.

### Example 8

To prepare a suspension concentrate according to the invention,

196 g of imidacloprid,
100 g of Arlatone T from Uniqema
90 g of Atlox 4894 from Uniqema
10 g of Borresperse NA from Borregaard LignoTech
0.5 g of Silicon Antischaummittel 1132 from Wacker
2 g of butylhydroxytoluene from Bayer
are introduced with stirring at room temperature into a mixture of
200 g of alkanol alkoxylate of the formula Id-1, and
401.5 g of sunflower oil.

After the end of the addition, the mixture is stirred at room temperature for a further 10 minutes. The resultant homogeneous suspension is subjected first to coarse grinding and then to fine grinding, giving a suspension in which 90% of the solids particles have a size of below 6 μm.

### Use Examples

Cofton plants (Gossypium hirsutum), which are infested with whitefly (Bemisia tabaci) eggs and larvae are sprayed with a composition of the desired composition and concentration. After the desired time, the destruction is determined in %. In this context, 100% means that all of the animals were destroyed; 0% means that no animals were destroyed.

| | % destruction after stated time at | | | |
|---|---|---|---|---|
| | stated active compound concentration | | | |
| Composition | Eggs/14 d | L1/10 d | L3/13 d | Adults/6 d |
| Prior art | 60 | 0 | 0 | 60 |
| Confidor ® SL200 | 150 g/ha | 12.5 g/ha | 5 g/ha | 5 g/ha |
| Inventive | 100 | 75 | 90 | 100 |
| Confidor ® OD200 | 150 g/ha | 12.5 g/ha | 5 g/ha | 5 g/ha |

1. A method for controlling eggs and nymphal stages of whitefly comprising applying, by spray application to plants, an oil-based suspension concentrate comprising at least one neonicotinyl insecticide.

2. The method according to claim 1, wherein the suspension concentrate comprises
at least one neonicotinyl insecticide,
at least one penetrant,
at least one vegetable oil,
at least one nonionic surfactant or dispersant, or at least one anionic surfactant or dispersant, or mixtures thereof, and
optionally one or more additives selected from the group consisting of emulsifiers, antifoam agents, preservatives, antioxidants, colourants, inert fillers and mixtures thereof.

3. The method according to claim 1, wherein the suspension concentrate comprises
5 to 40% by weight of at least one neonicotinyl insecticide,
5 to 55% by weight of at least one penetrant,
15 to 55% by weight of at least one vegetable oil,
2.5 to 30% by weight of at least one nonionic surfactant or dispersant, or at least one anionic surfactant or dispersant, or mixtures thereof and
optionally up to 25% by weight of one or more additives selected from the group consisting of the emulsifiers, antifoam agents, preservatives, antioxidants, colourants, inert fillers and mixtures thereof.

4. A method of controlling eggs and nymphal stages of whitefly, comprising applying an effective amount of at least one neonicotinyl insecticide to plants by spraying said plants with an oil-based suspension concentrate comprising at least one neonicotinyl insecticide.

5. The method according to claim 4, wherein the suspension concentrate comprises
at least one neonicotinyl insecticide,
at least one penetrant,
at least one vegetable oil,
at least one nonionic surfactant or dispersant, or at least one anionic surfactant or dispersant, or mixtures thereof, and
optionally one or more additives selected from the group consisting of emulsifiers, antifoam agents, preservatives, antioxidants, colourants, inert fillers and mixtures thereof.
